(19) United States
(12) Patent Application Publication
(10) Pub. No.: US 2010/0127927 A1
(43) Pub. Date: May 27, 2010

(54) METHOD AND DEVICE FOR IDENTIFYING, LOCATING AND POSITIONING OBJECTS IN A NON-EQUIPPED AREA

(75) Inventor: Gilles Rousset, Argenteuil (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/447,995

(22) PCT Filed: Oct. 29, 2007
(86) PCT No.: PCT/EP2007/061627

§ 371 Date: Dec. 8, 2009

(30) Foreign Application Priority Data
Oct. 31, 2006 (FR) 0609559

(51) Int. Cl. G01S 19/48; G01S 3/02; G01S 5/14

(52) U.S. Cl. 342/357.13; 342/451; 342/357.14

(57) ABSTRACT

The invention relates to a system for identifying, locating and positioning an object inside a given and unequipped zone, wherein the system comprises a radiofrequency module to receive identification of an object to be positioned in a predetermined location, one or more antennas to receive signals that originate from the object to be positioned, wherein said signals enable determination of a geographic position of the object to be positioned, a satellite positioning module, a memory to store information associated with the object to be positioned, a communication module for communication between the mobile platform and a central station to provide services by use of a specialized software program, wherein an object is fitted with RFID labels to enable transmission and reception of radiofrequency signals.

### CROSS-REFERENCE TO PRIOR APPLICATION

This is a U.S. National Phase Application under 35 U.S.C. §371 of International Application no. PCT/EP2007/061627, filed Oct. 29, 2007, and claims benefit of French Patent Application No. 06 09559, filed Oct. 31, 2006, both of which are incorporated herein. The International Application was published in French on May 8, 2008 as WO 2008/052967 under PCT Article 21 (2).

### FIELD OF THE INVENTION

The invention relates notably to a method and a device making it possible to locate, identify and position various objects in a storage or parking area, the objects being fitted with identification means, the area being able to be covered or uncovered.

It applies notably to the management of an area that is unequipped and has considerable dimensions.

It is used to position the various elements in the context of “improvised” management of a zone for temporary or semi-permanent storage, or for grouping a stream of packaged materials.

### PRIOR ART

The Digital Angel Corporation patent application WO2005041131, published on May 6, 2005, discloses, in a general manner, systems, methods and applications using the convergence of the following three technologies: wireless location, wireless communication and detection. The disclosed system comprises an identification label containing identification data, a reader-receiver which receives the identification information from the label, a receiver which receives the location data originating from the Global Positioning System (GPS), a transceiver which communicates the identification data and the location data to a central station, the provider of application services, which may, in its turn, communicate the identification and location data to an end-user. This patent application also describes various applications exploiting the capabilities of such a device.

The known solutions of the prior art for handling objects make it possible to identify, in a distinct manner and by using different devices, an object in an area with limited dimensions and fitted out to allow, in a fixed position, the location of the objects and the information interchanges between the various devices.

The most common solutions, in warehouses (limited and covered area) locate a handling device by a physical grid system of the ground (equipped area), and identify an object via a device installed on a handling system (reading of a medium for identifying objects).

Although the existing solutions are effective, they notably have the following disadvantages: the necessity to equip the management area with a fixed device, use on an area of limited size (around one hundred m² usually) or on a covered area.

In the rest of the description, the following terminology is used:

onboard system: an assembly installed on a vehicle, including the RFID (Radiofrequency Identification) portion, the GPS location portion and the wireless or Wi-Fi technology communication portion to an application comprising a specialist software program adapted for this new use,
location: a unique pair (GPS coordinates+identifier) which determines the location of a container (better known as a shelter) or of a pallet,
identification: a unique identification code associated with a label or a tag attached to a container or a pallet,
mapping: the assembly of all the locations of the containers and of the pallets. This information is stored in a database,

### GPS: the American Global Satellite Positioning System,

Galileo: the European global satellite radio-navigation system,
GNSS: the global radio navigation satellite system (generic name).

### SUMMARY OF THE INVENTION

An embodiment of the invention relates to a system for identifying, locating and positioning an object inside a given and unequipped zone, characterized in that it comprises at least the following elements:

a mobile platform comprising at least the following elements:
a radiofrequency module receiving the identifications of the objects to be positioned in a location decided in advance,
one or more antennae making it possible to receive signals originating from the object to be positioned and signals making it possible to know the geographic position of the object,
a satellite positioning module,
a means for storing the information associated with the object to be positioned,
a module for communication between the mobile platform and a central station providing services fitted with a specialist software program.
   An object is fitted with RFID labels making it possible to transmit and receive radiofrequency signals.

The invention notably has one or more of these advantages:
it is light (a few kilograms), transportable (“suitcase” type), fast to apply (a few minutes to fix the “suitcase” by activatable magnets and to open the protective end pieces of the radio communication antennae, for example),
it can be easily applied for large-sized areas (several km², for example), covered or uncovered, pre-equipped or not,
it allows a fixed or mobile terminal to retrieve the location of an object to within a few meters (approximately 3 meters), the location and the identification being able to be carried out globally or selectively at the time of the movement of the objects or not,
the location data with the addition of possible exploitation information are recorded in a base called the rear base but also optionally in the labels,
the accuracy that it provides is less than the distance for establishing the communication of the data acquisition/modification assembly. Therefore, the solution makes it possible to geoposition the objects in the immediate proximity (approximately 3 meters). This accuracy is less than the acquisition distance of the high-speed data transmission and communication assembly.

### BRIEF DESCRIPTION OF THE DRAWINGS

Other features and advantages of the present invention will more clearly appear on reading the description of an exemplary embodiment given as an illustration and in no way limiting, with the addition of the figures which represent:

FIG. 1, an interconnection block diagram of the indoor solution, or outdoor solution, and

FIG. 2, an exemplary onboard system.

### DESCRIPTION OF THE PREFERRED EMBODIMENTS

One of the objectives of the location system according to an embodiment of the invention is to allow the identification and location to within a few meters, on a storage or parking area, of objects equipped with RFID “tags” or labels. The abbreviation RFID corresponds to an automatic identification method using RFID labels or responders. In the case of an active label, it comprises antennae and elements the function of which is to receive and respond to interrogations transmitted by a transmitter.

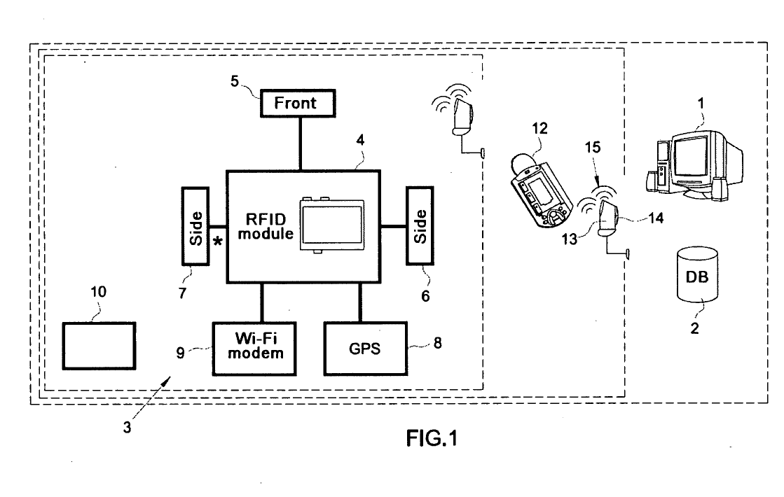

FIG. 1 is a block diagram of the interconnection for an indoor or outdoor solution. The system comprises for example:
a central system 1 to which several users may be subscribed, a rear base or storage zone 2,
a cart 3 equipped with a suitcase according to an embodiment of the invention containing, for example, the following elements:
   a radiofrequency or RFID module 4, the function of which is to communicate with the labels fitted to the various objects to be managed (location, identification, movement, positioning) in an area. This module receives, notably, the information for identifying the object (collected data),
   several antennae, in this exemplary embodiment, a front antenna 5, two side antennae 6, 7,
   a module 8 for positioning the cart, for example a GNSS (global navigation satellite system) module making it possible to obtain the information for the satellite positioning of the cart,
   a wireless communication module 9, of the Wi-Fi type. This module comprises a transceiver which communicates the data collected from the label (notably the identification data) and the location data to the central station 1, the provider of applications services, which may, in its turn, communicate the collected and location data to an end-user,
   a stand-alone power supply 10,
   a management unit and a database 11 making it possible to store collected data which the user desires to associate with an object or which originate from the object itself and are retrieved.
The operator 12.
   The cart 3 is equipped, for example, with means making it possible to pick up the identified object, to move it in order to bring it to its desired final position.

The objects 13 to be identified and positioned, fitted with a label 14 designed to receive the signals transmitted by the RFID module and to respond to this module. The object also comprises an external lamp 15 and/or sound indicator allowing it to be visibly and/or audibly identified by the user.

Initially, the objects are placed in a parking area.

The antennae are placed, for example, on the periphery of the suitcase and are protected by removable end pieces providing protection for the antennae, capable of re-entering into secure two-way communication with electronic data-storage devices installed on the objects to be identified and located.

The Wi-Fi modem 9 allows the communication and transmission of data at high speed, for example several megabits. The device according to an embodiment of the invention is therefore capable of being organized into a network with its possible counterparts that are several hundreds of meters away, or directly with a fixed connection point. Communication may therefore be established between the solution and its closest neighbor or with a fixed or mobile terminal which thereby collects all the geo-referenced identification data.

The GNSS system 8 used may be coupled, optionally supplemented by a gyroscopic device itself coupled or not depending upon the accuracy sought, to an odometer that is radio-connected to the solution, to be installed on one of the wheels of the platform. The geopositioning of the platform is therefore ensured.

The power supply unit 10 is for example an electric unit that can be recharged by virtue of its spiral cable that can be connected to a secondary current socket of the mobile platform on which the solution is installed. The unit may therefore be recharged and used at the same time.

The unit for managing the various elements also provides the temporary storage of the collected information. The unit may be controlled by a fixed or mobile terminal depending upon the adopted system configuration (several suitcases and several simultaneous networked users).

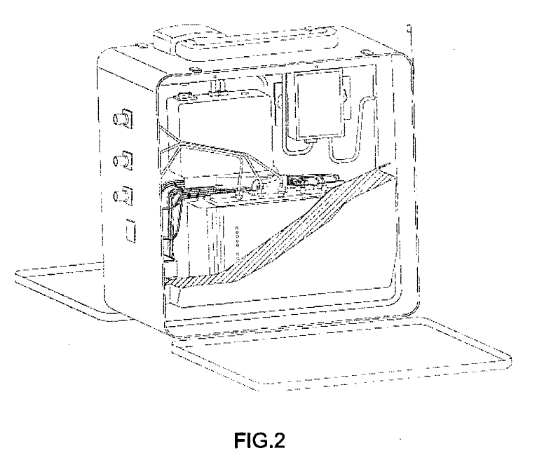

FIG. 2 represents an example of a system according to an embodiment of the invention which corresponds to the integration into an easily transportable device, in this instance a suitcase, of a geolocation device according to an embodiment of the invention comprising a secure, high-speed radio communication system capable of being organized into a network with its optional counterparts or being connected directly to a fixed or mobile terminal, makes it possible to perform all the functions in any area, even basic, covered or not, and on surface areas of several km², with real time situation holding.

The RFID radio part is constituted of a read/write module. Four antennae not shown for simplification reasons may be connected thereto. The reading distance is adjustable and may, depending on the tags used, be up to 100 meters.

Two removable side antennae make it possible to read the tags on each side of the vehicle in order to carry out the mapping and a front antenna performs the selective location function.

A GPS part allows the satellite positioning.

The communication part is, for example, formed by a modem.

The 12 V power supply is provided, for example, by the vehicle on which the suitcase is placed and should be regulated before supplying the various modules. The power supply connection system should be adapted to the vehicle.

In the case of an indoor application, for example, inside a shed or for the purpose of ensuring the receipt of the GPS signals, a GPS repeater kit is installed in the shed. This kit comprises for example an outdoor antenna pointed skyward, an indoor antenna pointed toward the wall opposite to the antenna, an amplifier and 20 meters of cable. The indoor antenna is, for example, installed at a height of 3 to 10 meters. Its field of action is 100 meters. In the case of a shed of greater length, the number of repeater kits is chosen accordingly. The repeater kit is supplied at between 3.1 and 15V.

According to another embodiment, and for the purpose of ensuring the reception of the GPS signals, in an enclosed application, a GPS kit comprising a gyroscope is used in order to determine the directions of the vehicle (supporting the system according to an embodiment of the invention); the distance information is supplied either by the odometer of the vehicle or by an additional kit performing this function. When the signal transmitted by the satellite is too weak, the gyroscope/odometer part takes over and resets itself on receipt of a GPS signal emanating from the satellites. In order to ensure good accuracy, a satellite reset is necessary every kilometer at the minimum.

In the case of a global mapping of the containers in an outdoor parking area, the system may be used in the following manner. The reading distance is regulated from the interrogator depending on the width of the aisles of the parking zone. A vehicle equipped with the system described above criss-crosses the parking zone where the containers are placed. The side antennae communicate with the labels or “tags” placed on the objects to be identified and positioned. The GPS coordinates are calculated directly, based on the information transmitted by satellites. The labels_id or tag_id identity information and GPS coordinates and other information (collected data) are transmitted from the interrogator to the central system.

The assembly installed on the cart makes it possible to carry out RFID mapping of the zone in an overall or selective manner:
the overall method, by criss-crossing the park using the side antennae,
the selective method, during the stacking of the pallet by virtue of the front antenna.
   The GPS coordinates are associated with each identifier, which provides the location function.

This information is transmitted to the application via the Wi-Fi link.

The labels are preferably positioned on the top of a container or on the lids. Similarly, for pallets, the labels are installed on the vertical panels of the pallets.

The quick and easy installation on a mobile platform, in an area, makes it possible to read or modify remotely, and to georeference at the precision of the satellite positioning and/or of a gyroscope-odometer combination, the information stored on devices for the storage or concentration of data attached to objects situated in this area.

The system according to an embodiment of the invention is used, for example, in cases of “event-specific” logistics: major event logistics, government and multinational meetings, military operations, etc., involving the convergence at one point of many objects, the identification and location of which contribute to the efficiency of the logistics management activities but also to the security of the events.

The system is used, for example, for storage zones of two types:
one is an outdoor parking zone with a large perimeter on which conventional GPS is available,
the other is an indoor storage zone, for example a shed, in which conventional GPS is unavailable.
   For operational reasons, it is possible to use:
containers outdoors which contain pallets that have reference information or have labels on them,
pallets indoors.
   Any other element fulfilling the same functions or identical functions may be used.

It is possible to envisage associating with the location message multiple data specific to the operation such as: the time-stamp, the regiment, the name or number of the operator, the content of the shelter or of the pallet, the GPS signal reception level, etc.

1. A system for identifying, locating and positioning an object inside a given and unequipped zone, wherein the system comprises:
a mobile platform comprising:
a radiofrequency module to receive identification of an object to be positioned in a predetermined location;
one or more antennas to receive signals that originate from the object to be positioned, wherein said signals enable determination of a geographic position of the object to be positioned;
a positioning module which obtains information for positioning;
a memory to store information associated with the object to be positioned; and
a communication module for communication of data between the mobile platform and a central station;
wherein an object is fitted with RFID labels to enable transmission and reception of radiofrequency signals.

2. The system as claimed in claim 1, wherein the system comprises one or more antennas positioned on a periphery of said system, and a protector designed to allow said one or more antennas to enter into secure two-way communication with an electronic data-storage device installed on the object to be identified and located.

3. The system as claimed in claim 1, wherein the positioning module includes a satellite-positioning module and is coupled to a gyroscopic device, and the gyroscopic device is coupled to a radio odometer installed on a wheel of the mobile platform.

4. The system as claimed in claim 1, wherein the positioning module comprises a gyroscopic device.

5. The system as claimed in claim 1, wherein the system comprises a rechargeable electric power supply unit.

6. The system as claimed in claim 1, wherein the system comprises a management unit and a database controlled by a terminal.

7. The system as claimed in claim 1, wherein the mobile object to be identified comprises a container fitted with an RFID label.

8. The system as claimed in claim 1, wherein the mobile platform comprises a device designed to be carried by a user.
